(19) United States
(12) Patent Application Publication
(10) Pub. No.: US 2006/0242385 A1
(43) Pub. Date: Oct. 26, 2006

(54) Dynamically reconfigurable processor

(75) Inventors: Kazuaki Murakami, Fukuoka (JP); Makoto Shuto, Fukuoka-shi (JP); Lovic Gauthier, Fukuoka-shi (JP); Takuma Matsuo, Fukuoka-shi (JP); Tetsuya Hasebe, Tokyo (JP); Shuichi Kikuchi, Kanagawa (JP)

Correspondence Address: BAKER & MCKENZIE LLP;PATENT DEPARTMENT, 2001 ROSS AVENUE, SUITE 2300, DALLAS, TX, 75201, US

(73) Assignee: Tokyo Electron, Inc.

(21) Appl. No.: 11/267,026

(22) Filed: Nov. 4, 2005

(30) Foreign Application Priority Data
Nov. 30, 2004 (JP) JP2004-345400

(51) Int. Cl. G06F 9/30

(52) U.S. Cl. 712/200

(57) ABSTRACT

Disclosed is a technology of generating an instruction set architecture (hereinafter, referred to as ‘ISA’) and a series of logic circuit configuration information of a processor for executing an application program from an application program described in a high-level language. The present invention also relates to a custom LSI development platform technology which can design, develop, and manufacture the application specific custom LSI in a short time by applying the generated ISA and logic circuit configuration information to a dynamic logic circuit reconfigurable processor. Furthermore, disclosed is a dynamically reconfigurable processor, which is reconfigurable using the generated logic circuit configuration information. Associated methods are also disclosed.

### CROSS-REFERENCE TO RELATED APPLICATION

This Application claims the benefit of Japanese Patent Application No. JP 2004-345400, filed on Nov. 30, 2004, and entitled “Custom LSI Development Platform, Instruction Set Architecture, Method For Generating Logic Circuit Configuration Information, And Program”, commonly assigned with the present application and incorporated herein by reference in its entirety for all purposes.

### TECHNICAL FIELD

Disclosed embodiments herein relates to logic circuit development, and more particularly to a technology for designing, developing, and manufacturing an application specific custom LSI.

### BACKGROUND

In a field using a custom LSI including an application specific integrated circuit (ASIC), in order to shorten a period for changing a specification or developing a product, a programmable logic circuit, such as a field programmable gate array (FPGA) or a programmable logic device (PLD), which can freely change the configurations of the logic circuits in a processor, has been widely used. However, as configurations of the logic circuits required for the custom LSI become complicated and the scales thereof increase, there is a problem in that a plurality of arithmetic and logic units (ALUs) must be provided in the FPGA or the PLD.

In logic circuits having a large scale, considering that all of the components do not always operate, a dynamic logic circuit reconfigurable process, which can dynamically reconfigure the logic circuit of the process, has been suggested in Japanese Patent Applications JP-A No. 2003-198362 and JP-A No. 2003-029969.

When designing and developing the system of the custom LSI, it must be determined which of the applications is realized by hardware and which of the applications is realized by software. If all the applications can be realized by hardware, high operation speed and low power consumption can be realized.

However, designing and developing costs increase, such as those related to chip manufacturing, the designing period, and the hardware designer. In contrast, if the software that operates on a general-purpose processor realizes all of the applications, it is difficult to accomplish the required system performance, but the designing and developing cost is reduced. One problem when a software developer develops the custom LSI is that the developer usually must use a hardware description language (HDL) that is not typically familiar to the software developer, such as ‘Verilog-HDL’ or ‘VHDL’, in describing the specification of the custom LSI. A lot of time is typically required to prepare the code of this HDL, because the code has a large amount of description. In addition, it often takes a long time to perform the compile or simulation for the code.

A high-level language or a modeling tool having high abstraction, such as C language, is mainly used for examining an algorithm applied to the LSI. However, if the logic circuit is prepared using the algorithm created in a high-level language, the examined algorithm should be rewritten in the HDL, and thus the preparing time increases. In addition, a potential problem is that once the logic circuit configuration is created in the HDL, it is difficult to change the algorithm. Another a problem is that the software developer usually must consider a specific limit of the hardware in the operation synthesizing step.

### BRIEF SUMMARY

Disclosed is a technology of generating an instruction set architecture (hereinafter, referred to as ‘ISA’) and a series of logic circuit configuration information of a processor for executing an application program from an application program described in a high-level language. The present invention also relates to a custom LSI development platform technology which can design, develop, and manufacture the application specific custom LSI in a short time by applying the generated ISA and logic circuit configuration information to a dynamic logic circuit reconfigurable processor. Furthermore, disclosed is a dynamically reconfigurable processor, which is reconfigurable using the generated logic circuit configuration information.

It is an object of the present invention to provide a custom LSI development platform in which when a software developer prepares an application program in a high-level language, for example, C language, an instruction set architecture (ISA) and logic circuit configuration information are automatically generated based on the created application program. The generated ISA and logic circuit configuration information are then automatically applied to a dynamically reconfigurable logic circuit processor. It is another object of the present invention to provide a software module for generating an ISA and logic circuit configuration information from an application program created in a high-level language, and a dynamic logic circuit reconfigurable processor to which the generated ISA and logic circuit configuration information are automatically applied. It is a further object of the present invention to provide a program for generating an ISA and logic circuit configuration information from an application program created in a high-level language.

According to a first aspect of the present invention, there is provided a custom LSI development platform including a processor and a software module. The processor is a dynamic logic circuit reconfigurable processor. The software module includes an ISA generator for generating an ISA of the processor; and a logic circuit configuration generator for generating logic circuit configuration information of the processor from layout arrangement information of a programmable element (PE) constituting logic circuits of the processor and the ISA. The ISA generator includes a means for extracting the pattern of an instruction of a program described in a high-level language, and a means for comparing the pattern of the extracted instruction with the pattern of a custom instruction stored in a library. In addition, the ISA generator comprises a means for substituting the extracted instruction with the custom instruction and/or combination of the custom instructions. The ISA generator further includes a function call that is a means for calling the extracted custom instruction, and a means for generating a middle code including a control instruction of the processor.

The software module includes a means for converting the middle code and the custom instruction into an object code. The software module further includes a means for generating a logic circuit configuration object code from the logic circuit configuration information, and a simulator for simulating the performance of the ISA. In such embodiments, the software module further includes a creator for generating as a new custom instruction an instruction that is not substituted with the custom instruction during the process for substituting the extracted instruction with the custom instruction. The processor includes a dynamic reconfigurable logic circuit, a configuration memory for storing the logic circuit configuration information of the custom instruction, and a memory for storing the extracted custom instruction. In addition, the processor could include a register file for temporarily holding the result of executing the extracted custom instruction, and a controller for reading the logic circuit configuration information corresponding to the custom instruction from the configuration memory and reconfiguring the dynamic reconfigurable logic circuit when executing the custom instruction. Moreover, the controller can further include an index register for storing an index when accessing the memory, while the processor could further include a stack for storing a value of the index register.

According to a second aspect of the present invention, there is provided a method for generating an ISA of a processor, including extracting the pattern of an instruction of a program described in a high-level language, comparing the pattern of the extracted instruction with the pattern of a custom instruction stored in a library, and substituting the extracted instruction with the custom instruction and/or combination of the custom instructions to generate the ISA. In some embodiments, the logic element connection information substituted with the custom instruction is extracted, and the ISA is generated to include the logic element connection information. In addition, the logic element connection information may be stored in the library so as to be associated with the custom instruction. The instruction that is not substituted with the custom instruction among the program instructions in the process for substituting the program instruction with the custom instruction and/or combination of the custom instructions is created as a new custom instruction and is added to the library to extract the custom instruction again.

According to a third aspect of the present invention, there is a method for generating logic circuit configuration information of a processor that includes extracting the pattern of an instruction of a program described in a high-level language, comparing the pattern of the extracted instruction with the pattern of a custom instruction, and substituting the extracted instruction with the custom instruction and/or combination of the custom instructions. In this embodiment, the method also includes generating the logic circuit configuration information from logic element connection information associated with the custom instruction and layout arrangement information of a programmable element of the processor. In such embodiments, the logic element connection information may be stored in a library, and the processor may be a dynamic logic circuit reconfigurable processor.

According to a fourth aspect of the present invention, there is provided a dynamically reconfigurable microprocessor comprising a program stack operable to receive a plurality of program instructions, where the program instructions comprises at least first and second instruction sets. In addition, the processor includes a reconfigurable logic circuit in electrical communication with the program stack, where the reconfigurable logic circuit has alternative first and second data paths whereby data to be operated on according to the first instruction set passes through the first data path and data to be operated on according to the second instruction set passes through the second data path. In such embodiments of a processor, the reconfigurable logic circuit is reconfigurable according to whether instructions corresponding to the first or second instruction set are being executed by the microprocessor.

According to a fifth aspect, disclosed in a method of dynamically reconfiguring processing circuitry. In one embodiment, the method comprises receiving a plurality of program instructions to be executed by the processing circuitry, where the program instructions comprise at least first and second instruction sets. The method further comprises configuring a reconfigurable logic circuit in a first data path when operating on data according to the first instruction set, and configuring the reconfigurable logic circuit in a second data path when operating on data according to the second instruction set;

According to a sixth aspect of the present invention, there is provided a dynamic logic circuit reconfigurable processor. The processor may include a dynamic reconfigurable logic circuit, a configuration memory for storing layout arrangement information for each instruction of a programmable element (PE) constituting the dynamic reconfigurable logic circuit, a register file for temporarily holding a middle result of executing an instruction; a memory for storing the instruction, and a controller for managing the processor including executing order of the instruction. The controller further includes an index register for storing an index when accessing the memory, while the processor further includes a stack for storing a value of the index register.

According to a seventh aspect of the present invention, there is provided a computer-readable medium containing a set of instructions to be executed in a computer for generating an instruction set architecture of a dynamic logic circuit reconfigurable processor. The set of instructions provides the steps of extracting an instruction pattern from an instruction in an application program of the processor described in a high-level language, comparing the extracted instruction pattern with patterns of one or more custom instructions stored in a library, and substituting the instruction in the program with the one or more custom instructions to generate the instruction set architecture. In an eighth aspect, the instructions further include the step of generating the logic circuit configuration information from logic element connection information associated with the one or more custom instructions included in the instruction set and from layout arrangement information of at least one programmable element of the processor.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 is a block diagram illustrating the entire structure of one embodiment of a custom LSI development platform according to the present invention;

FIG. 2 is a detailed block diagram of one embodiment of a software module;

FIG. 3 is a detailed block diagram of one embodiment of an ISA generator;

FIG. 4 is a block diagram of one embodiment of a dynamic logic circuit reconfigurable processor according to the present invention;

FIG. 5 is a functional block diagram of one embodiment of a dynamic logic circuit processor according to the present invention;

FIG. 6 is a diagram illustrating the structure of an instruction format;

FIG. 7 is a diagram illustrating the structure of a reconfigurable data path according to an embodiment of the present invention;

FIG. 8 is a diagram illustrating a flow of an AES encryption process conducted in accordance with the disclosed principles;

FIG. 9 is an exemplary description of a middle code of the AES encryption process;

FIG. 10 is another exemplary description of the middle code of the AES encryption process; and

FIG. 11 is a flowchart of a DES encryption process conducted in accordance with the disclosed principles.

### DETAILED DESCRIPTION

Disclosed is a technology of generating an instruction set architecture (hereinafter, referred to as ‘ISA’) and a series of logic circuit configuration information of a processor for executing an application program from an application program described in a high-level language. Further, the present invention relates to a custom LSI development platform technology which can design, develop, and manufacture the application specific custom LSI in a short time by applying the generated ISA and logic circuit configuration information to a dynamic logic circuit reconfigurable processor. In accordance with the disclosed principles, a software developer can employ the disclosed technology to develop an application without considering hardware characteristics. As a result, the entire execution cycle number required for the development can be reduced and thus an application specific custom LSI can be developed in a short time. Further, commonness (platform) of property for developing the custom LSI is possible, and the design and development property can be standardized.

Before describing the disclosed technology in detail, some terms use throughout this disclosure should first be defined. In the present disclosure, a “dynamic logic circuit reconfigurable processor” is a processor having a function that dynamically reconfigures and processes a logic circuit in a processor according to an instruction. A “custom LSI” is an LSI including an application specific integrated circuit (ASIC) that is designed and manufactured according to needs. A “custom instruction” is an instruction that is executed by a process and defined by a user. An “instruction set” is a series of instruction codes included in a processor. An “instruction set architecture” (ISA) is composed of logic element connection information required for generating logic circuit configuration information of a processor and an instruction set. The “logic element connection information” is information defining, for example, an AND circuit, an OR circuit, and an XOR circuit in this order. Accordingly, on the logic circuit of the dynamic logic circuit reconfigurable processor, the information on where the AND circuit, the OR circuit, or the XOR circuit is located, or which wiring lines connects the AND circuit, the OR circuit, and the XOR circuit to one another, is not included. A “custom logic circuit” is a logic circuit for realizing a custom instruction, and is a circuit or a function that cannot be realized in a general-purpose processor due to the performance. A “platform” is a system composed of common hardware and software that can be used for realizing a different custom logic circuit. A “data path” is a logic circuit of a processor for executing a custom instruction. A “programmable element” is an element for constructing a logic circuit, such as the AND circuit, the OR circuit, the XOR circuit, or an ALU circuit.

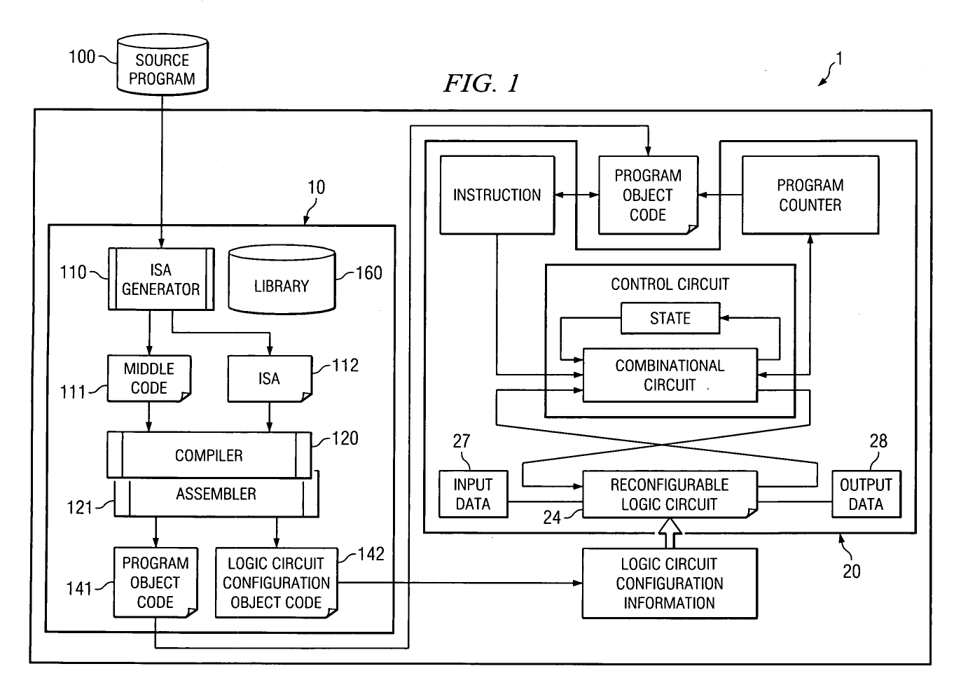

With these definitions in mind, reference is now made to FIG. 1, which illustrates a block diagram illustrating the overall structure of one embodiment of a custom LSI development platform 1 according to the present invention. The custom LSI development platform 1 includes a dynamic logic circuit reconfigurable processor 20 and a software module 10. The software module 10 is composed of a series of software for generating logic circuit configuration information for dynamically changing an ISA in the dynamic logic circuit reconfigurable processor 20 and a reconfigurable logic circuit 24 (reconfigurable data path) in the dynamic logic circuit reconfigurable processor 20 for each custom instruction.

If a software developer describes a source program 100 in a C language, an ISA generator 110 generates and compiles a middle code 111 and an ISA 112 to generate a program object code 141 and a logic circuit configuration object code 142. The dynamic logic circuit reconfigurable processor 20 processes operation of input data 27, while changing a reconfigurable logic circuit 24 for each custom instruction based on the program object code 141 and the logic circuit configuration object code 142, and outputs data 28 as a final result.

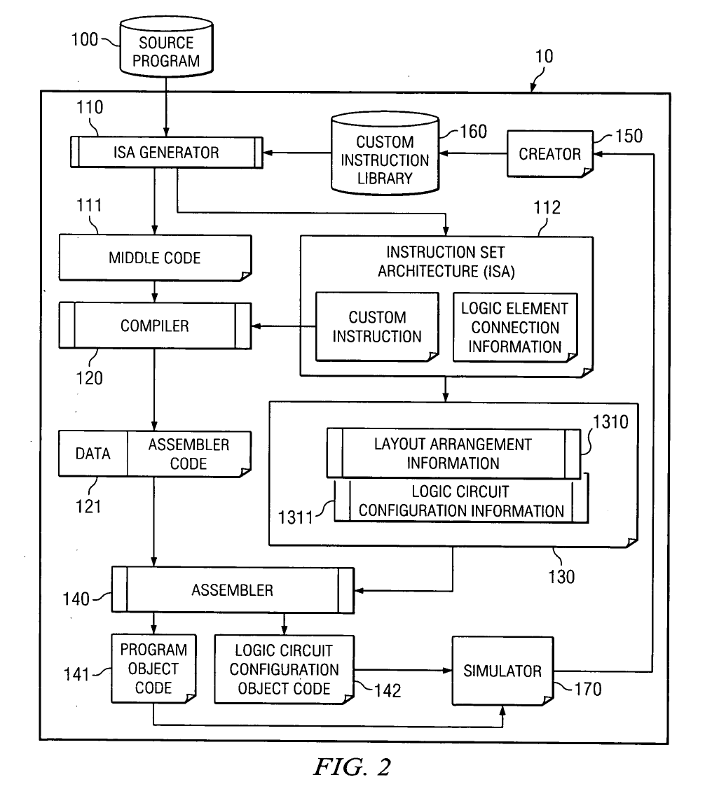

FIG. 2 is a detailed block diagram of the software module 10 illustrated in FIG. 1. If the C source program 100 is applied, an ISA generator 110 starts up and analyzes the instruction structure of the C source program 100. Also, in a custom instruction library 160, a plurality of custom instructions which are previously defined are stored. The ISA generator 110 extracts the pattern of the instruction that is in use or is repeatedly used in the C source program 100, compares it with the pattern of the custom instruction in the library 160, substitutes the instruction in the C source program 100 with the custom instruction, and generates the middle code 111 and the ISA 112.

The middle code 111 is composed of a function call of the custom instruction and a control instruction, and the ISA 112 is composed of a custom instruction and logic element connection information. The middle code 111 is compiled to an assembler code 121 by a compiler 120 and then becomes a program object code 141. Further, the compiler 120 compiles the middle code 111 and the custom instruction of the ISA 112, for example, the custom instruction that multiplication is defined as ‘x’ to the assembler code 121. The custom instruction of the ISA 112 is converted into the assembler code 121 together with the middle code 111 by the compiler 120, and then becomes the program object code 141 by the assembler 140.

A logic circuit configuration generator 130 generates logic circuit configuration information 1311 from the logic element connection information of the ISA 112 and layout arrangement information 1310 of a programmable element (PE) of a reconfigurable logic circuit 24. It then converts it into the logic circuit configuration object code 142 by the assembler 140. The software module further includes a simulator 170 for simulating the performance of the ISA 112, specifically, program object code 141 and the logic circuit configuration object code 142.

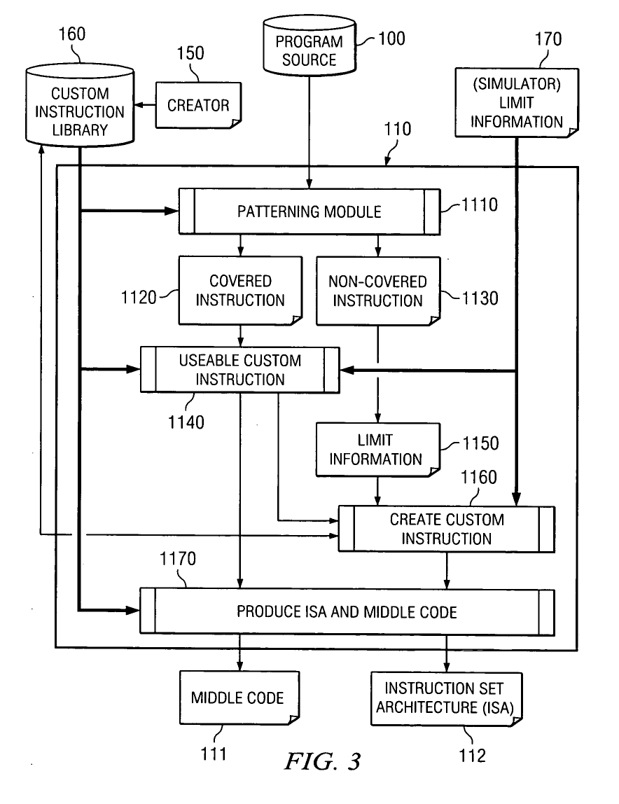

FIG. 3 is a detailed block diagram of the ISA generator 110. As shown in FIG. 3, a patterning module 1110 extracts an instruction that is in use or is repeatedly used in the C source program 100 with reference to the library 160, compares the pattern of the extracted instruction with the pattern of the custom instruction stored in the library 160, and substitutes an identical instruction with the custom instruction (1140). Various instructions that were not extracted as the custom instructions (were not previously created as the custom instructions) by the patterning module 1110 are newly defined and created by a creator 150, or are synthesized to the existing custom instruction and defined as new custom instructions (1160) if the various instructions can be synthesized to the existing custom instruction. The custom instructions of the library 160 are always updated by the addition and synthesis of the custom instruction (1160).

The patterning module 1110 substitutes the instruction of the C source program 100 with the custom instruction until the entire C source program 100 can be executed. This includes covered instructions 1120 and non-covered instructions 1130. In addition, the patterning module 1110 generates the logic circuit configuration information of the reconfigurable logic circuit 24 for each custom instruction, with reference to the logic element connection information (associated with the custom instruction and stored in the library 160) and the layout arrangement information 1150 of the PE. The ISA generator 110 thus produces (1170) the ISA 112 and Middle Code 111.

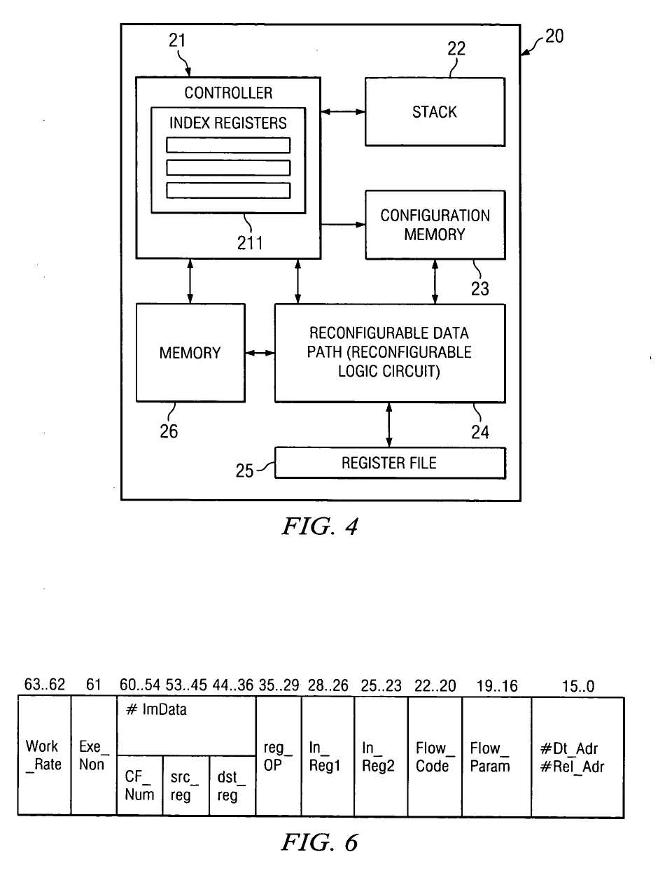

FIG. 4 is a block diagram showing a dynamic logic circuit reconfigurable processor 20 according to an embodiment of the present invention. The dynamic logic circuit reconfigurable processor 20 includes the reconfigurable data path (reconfigurable logic circuit) 24 and executes programs by sequential control. The dynamic logic circuit reconfigurable processor 20 executes the process content of the C source program 100 while resetting the logic circuit configuration for each step. Further, the step is a period that is required for executing one instruction, including the setting of the logic circuit configuration and the execution of the operation. Also, the logic circuit configuration information is configuration information of the reconfigurable logic circuit for executing the custom instruction.

The dynamic logic circuit reconfigurable processor 20 includes a controller 21, a stack 22, a configuration memory 23, a reconfigurable data path 24, a register file 25, and a memory 26. The controller 21 performs the entire management of the dynamic logic circuit reconfigurable processor 20, such as a load of the configuration data and a load of data in the memory 26. The controller 21 includes seven 22-bit index registers 211 formed therein and can access the memory 26 using the value of the index register 211. Also, the controller 21 is connected to the stack 22 for storing the value of the index register 211. The memory 26 is a storage device for storing the instruction of the dynamic logic circuit reconfigurable processor 20.

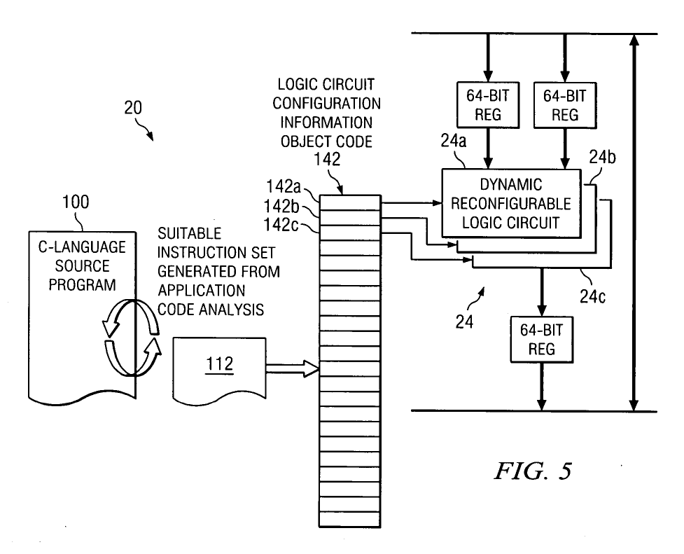

FIG. 5 illustrates a functional block diagram of the dynamic logic circuit processor 20 illustrated in FIG. 4. The functional diagram illustrates dynamically reconfiguring a logic circuit from a high-level language source program, in accordance with the disclosed principles. As mentioned above, an ISA generator analyzes the instruction structure of the high-level source program 100. The ISA generator extracts the pattern of the instruction that is in use or is repeatedly used in the C source program 100, and compares it with the pattern of the custom instruction in the library. The ISA generator then substitutes the instruction in the source program 100 with the custom instruction, and generates the middle code (see above) and the ISA 112.

The ISA 112 is composed of a custom instruction(s) and logic element connection information. Logic circuit configuration information is generated from the logic element connection information of the ISA 112 and layout arrangement information of a PEs of the reconfigurable logic circuit 24. The logic circuit configuration information is then converted into the logic circuit configuration object code 142. This is typically done by an assembler, such as the assembler 140 described above. According to one embodiment, multiple sets of logic circuit configuration information object code 142 can be created. In FIG. 5, examples of such object codes are labeled 142a, 142b, 142c, however, there is no limit to the number of various object codes that may be generated, and in exemplary embodiments, the most suitable instruction set is used. Each set of object code 142a, 142b, 142c provides for a corresponding configuration in the dynamic reconfigurable logic circuit 24. These are labeled as 24a, 24b, 24c, respectively, and represent distinct configurations in the programmable logic elements comprising the logic circuit 24. Once the desired logic circuit 24 configuration is created, 64-bit registers are used in this embodiment to execute the desired code with the selected configuration.

The dynamic reconfigurable logic circuit processor 20 disclosed herein is reconfigurable to provide processing operations typically provided by multiple dedicated processing units. For example, at one point the processor 20 may be configured to function as a central processing unit of a computer, while at a second point in time it is configured to operate as an application specific processor, and then at a third point in time it is configured to operate as a digital signal processor. By providing multiple processing functions as disclosed herein with a single processor 20, the disclosed principles result in a reduced overall device size and space. In addition, flexibility in processing capabilities is increased without increasing manufacturing costs. Specifically, the logic elements within the processor 20 are mapped to the particular application to be executed. As a result, each application is executed more efficiently with the disclosed technique, since each distinct application is executed by hardware reconfigured for each application. Moreover, such reconfiguration of the processor 20 is accomplished automatically from the application codes to be processed.

FIG. 6 illustrates the structure of the instruction format stored by the memory 26. In FIG. 6, in the section ‘Exe.Non’, it is determined whether the instruction is executed by the operation with the reconfigurable data path 24, or is executed only by the manipulation of the value of the index register 211 without using the reconfigurable data path 24. If the instruction is executed by the operation with the reconfigurable data path 24, the address of the configuration memory 23 in which adequate configuration data are stored and the register file 25 used for the operation are designated. If the instruction is executed by the manipulation of the value of the index register 211, the operation content and the index register 211 used for the operation are designated. If the memory address is designated in the section ‘ImData’, the exchange of the data between the memory 26 and the index register 211 can be executed.

In the section ‘Flow-Code’, the executing order control of the program can be designated, and, if the branch condition can be designated, the process can be branched using the operation result at the reconfigurable data path 24. The sections ‘Dt_Adr’ and ‘Rel_Adr’ are used for designating a relative address. The section ‘Work_Rate’ can be used for designating the clock cycle number when executing the process by the reconfigurable data path 24 by 1, 2, 4 or 8 clock cycles according to the process content.

Looking briefly back at FIG. 4, the configuration memory 23 is a memory for storing the configuration data. The configuration memory 23 can store 128 configuration data of the custom instruction. The register file 25 is a register for storing the operation result at each PE of the reconfigurable data path 24 and transferring it to a different function. One word has a 256-bit width. The register file 25 is connected to the PE of the reconfigurable data path 24 and the bit location of the stored register file 25 is determined depending on the location of the PE for outputting data.

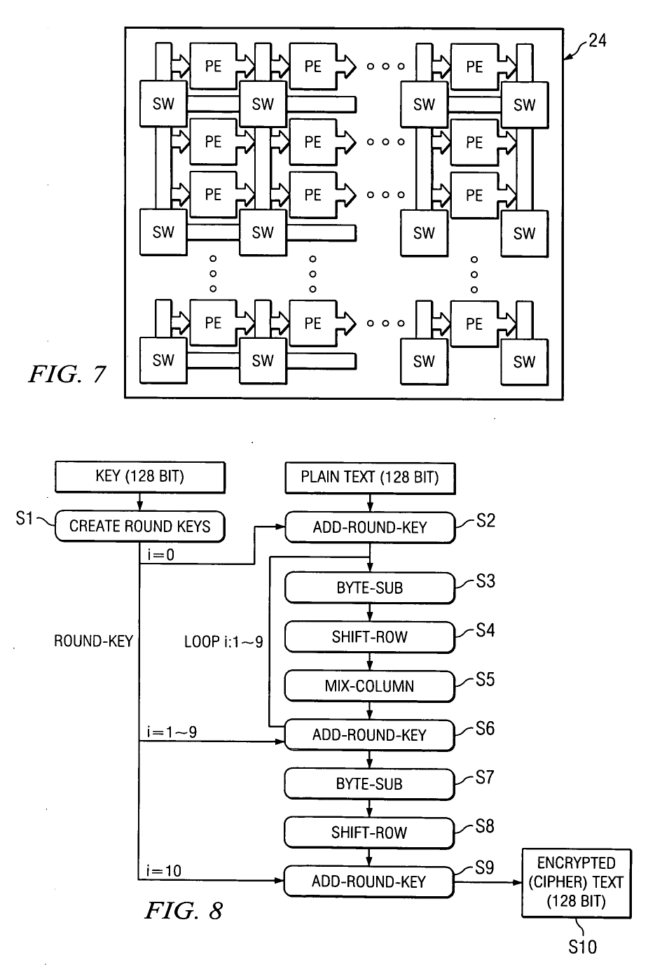

FIG. 7 illustrates the structure of the reconfigurable data path 24 according to an embodiment of the present invention. In the reconfigurable data path 24, the PEs are arranged in 16 rows×8 columns. The PEs have six inputs and two outputs and can allocate any logic function to the input. The PEs are connected to each other by a vertical line (VL) and a horizontal line (HL). The VL is connected to the respective PEs of one column and each VL is connected to the HL. A switching unit (SW) controls the exchange of the signal from the VL to the HL or from the HL to the VL. The VL has a 64-bit width and the number thereof is 8, and the HL has a 64-bit width and the number thereof is 7. Also, 64-bit data can be loaded from the memory to the reconfigurable data path 24 at a time.

In the dynamic logic circuit reconfigurable processor 20, the controller 21 reads the program from the memory 26 and determines whether the instruction uses the reconfigurable data path 24 or operates only the value of the index register 211. In a case of using the reconfigurable data path 24, the controller 21 reads adequate configuration data from the address of the configuration memory 23 designated in the program and loads this data to the reconfigurable data path 24. The reconfigurable data path 24 performs the process of the input data if the configuration (logic circuit configuration) is fixed. The operation result executed in each PE can be output to the VL and written in the register file 25. As a middle result, the data can be transferred to a separate function and can be used. By using the register file 25, a large process can be divided into a plurality of functions and can be then executed. In a case of using the value of the index register 211, since an operation circuit is prepared in the index register 211, the operation designated in the program is performed in the operation circuit and is transitioned to a next instruction.

### Embodiment 1

By using the software module 10 and the dynamic logic circuit reconfigurable processor 20 according to an embodiment of the present invention, an encryption custom LSI of an advanced encryption standard (AES) was developed. The AES is selected as a standard encryption method for substituting a date encryption standard (DES). The ISA is generated from the program of the AES created in the C language, and the AES encryption process was performed in the dynamic logic circuit reconfigurable processor 20 to perform the performance evaluation. In the AES, the bit number of the plain text or the bit number of the key can be selected. However, in this embodiment, both of them were set as 128 bits.

FIG. 8 illustrates a flow of the AES encryption process. First, a data-format plain text of two-dimensional arrangement called ‘State’ is arranged. A round key is generated (S1), and an exclusive OR of State and the round key is performed (S2). The round function is executed a predetermined number of times. In this embodiment, the round function was executed 9 times in the following condition. The round function is executed by next 4 conversions. First, an s-box converting process having 8-bit input and 8-bit output (byte-sub) is executed (S3). Next, Shift-Row for executing periodic shift of a byte unit with respect to a row is executed (S4). Next, Mix-Column to be a matrix operation for each column is executed (S5). In addition, the exclusive OR (Add-Round-Key) of State and the round key is executed (S6). The steps S3 to S6 are repeatedly executed nine times. Finally, Byte-sub (S7), Shift-Row (S8), and Add-Round-Key (S9) are executed and the encryption text (Encrypted) is obtained (S10).

The four converting processes of Byte-sub, Shift-Row, Mix-Column, and Add-Round-Key become the core of the encryption process. When executing the four converting processes, the custom instruction for realizing each converting process was created. In this embodiment, Byte-sub, Shift-Row, Mix-Column, and Add-Round-Key are divided into units of 32 bits, 128 bits, 64 bits, and 128 bits, respectively. For this reason, an instruction for dividing and combining the data was added.

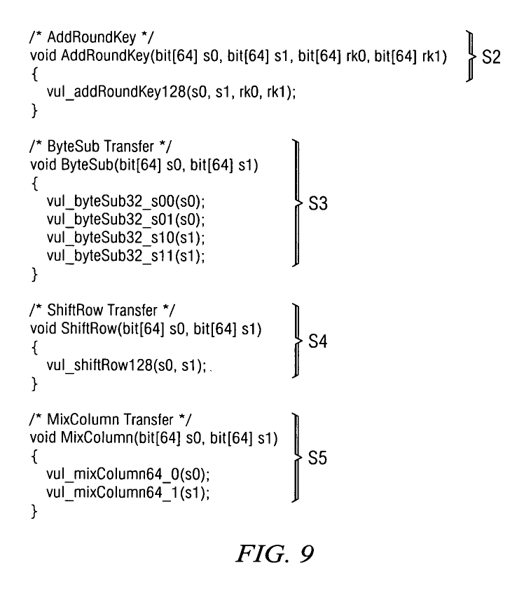

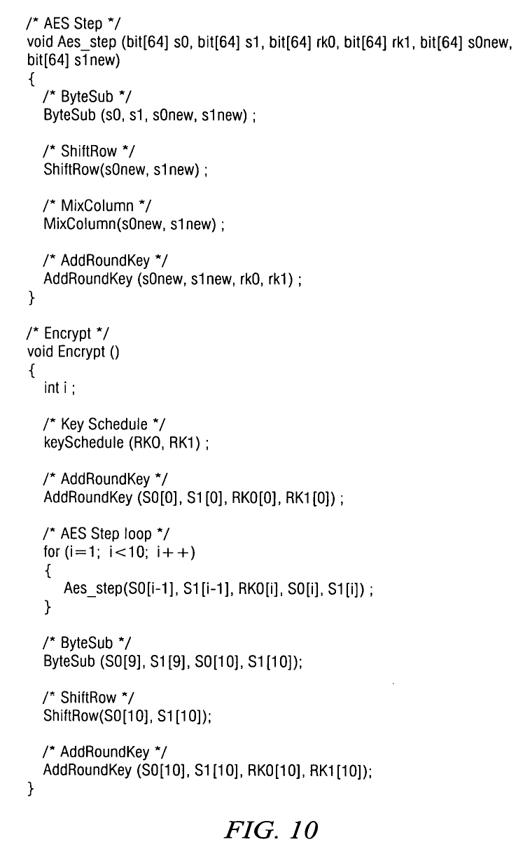

FIG. 9 and FIG. 10 are examples of the middle code 111 of the AES encryption process that is described in the C language, including Byte-sub, Shift-Row, Mix-Column, and Add-Round-Key. As shown in FIGS. 9 and 10, the main routine of the AES encryption process is an ‘encrypt’ function. In the middle code of FIG. 9, the head of the custom instruction is attached with ‘vul.’. Thereby, 309 cycles are obtained in the entire process and 79 cycles are obtained in the encryption process.

### Embodiment 2

The DES is an encryption standard standardized in the National Institute of Standards and Technology. By inputting 64-bit plain text and 56-bit key as a public key encryption using the same key in the encryption and decryption, 64-bit encryption text is output. In the DES encryption process, a 64-bit string is first input and is subjected to initial transpose based on a transposed table. The transposed bit string is divided by 32 bits. The divided bit strings are encrypted by the key and the encryption function F, respectively. The key uses 48-bit round key generated from the input 56-bit key. This process is performed 16 times, and the created left and right bit strings are combined to perform final transpose. Thus, the result is output as the encryption text.

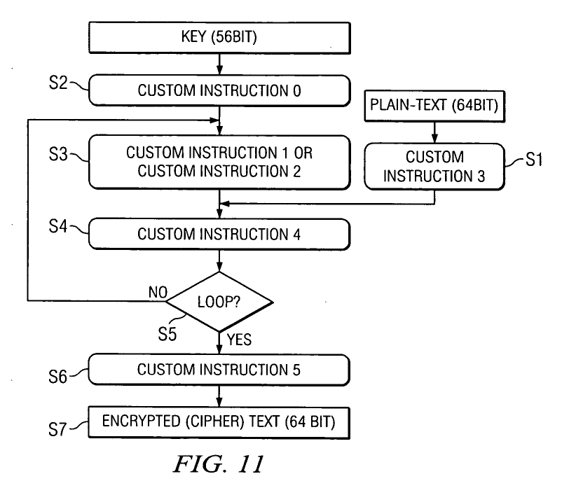

FIG. 11 is a flowchart of the DES encryption process. In the DES encryption process of the dynamic logic circuit reconfigurable processor 20, 6 custom instructions were required. Table 1 represents the custom instructions used in the DES encryption process and the contents thereof.

TABLE 1

| Custom | |
|---|---|
| instruction | Content |
| 0 | Read of the key and transpose of the key generating unit |
| 1 | Read of the plain text and initial transpose |
| 2 | Left cyclic shift of the key generating unit by 1 bit |
| 3 | Left cyclic shift of the key generating unit by 2 bits |
| 4 | Reduction transpose and F function of the key generating unit, |
| | and the exclusive OR |
| 5 | Inverse of the initial transpose and output |

First, a 56-bit key is input from the memory to the reconfigurable data path 24 by the instruction 0, and the transpose thereof is simultaneously executed. Similarly, 64-bit plain text is input by instruction 1, and the initial transpose thereof is simultaneously executed. Next, the cyclic shift of the key is executed by instruction 2 or 3 according to the round number. In instruction 4, the reduction transpose of the key and the encryption F function are executed by one instruction.

The exchange of the data between the instructions is performed through the register file 25. This round is repeated 16 times. In FIG. 11, the repetition is performed by the conditional branch process, but in the present embodiment, the repetition is developed and is sequentially performed. This is to reduce the designed circuit scale and because a redundant circuit for determining the round number must be made in order to execute the conditional branch process. Finally, the inverse of the initial transpose is performed, and a 64-bit cipher text is output in the memory.

Table 2 represents an operation frequency and throughput when performing the DES encryption process by the dynamic logic circuit reconfigurable processor 20. In this embodiment, the operation frequency of the DES encryption process was 6.25 MHz. For comparison, the result of performing the DES encryption process by an Intel Pentium® 4 is shown in Table 2.

TABLE 2

| | Operation frequency | Throughput |
|---|---|---|
| Vulcan | 6.25 MHz | 570 KB/sec |
| Pentium 4 | 2.4 GHz | 150 KB/sec |

The DES encryption process of the Pentium® 4 was executed by compiling the description of the specification of the DES encryption process by the C language. In the compile option, —O2 was used. The DES encryption process of the dynamic logic circuit reconfigurable processor 20 from Table 2 represents performance higher than the DES encryption process of Intel Pentium (registered trademark) 4 by 3.8 times. This is because the characteristic that the PE serving as the component of the dynamic logic circuit reconfigurable processor 20 can allocate any logic function to the input by one bit unit can be used in the DES encryption process.

In the DES encryption process, the transpose or the substitution of one bit unit is repeated. In a 32-bit microprocessor, such as the Intel Pentium® 4, when executing the process by one bit unit the process of extracting one bit is required. In the transpose process by one bit unit, the PE of the dynamic logic circuit reconfigurable processor 20 inputs the data from the register file 25 to the reconfigurable data path 24, moves it to a designated bit location, and stores it in the register file 25 again. Thereby, a large amount of data transpose processes can be performed by one instruction. In addition, since the PE can allocate any logic function to the input, a plurality of the processes depending on the data are synthesized and are executed by one instruction, thereby reducing the executed clock cycle number. In the DES encryption process of the reconfigurable data path 24, the clock cycle number required for the 64-bit plain text encryption was 70 cycles.

In sum, the present invention provides a custom LSI development platform in which when a software developer prepares an application program in a high-level language, for example, C language, an ISA and logic circuit configuration information are automatically generated based on the created application program. The generated ISA and logic circuit configuration information are then automatically applied to a dynamically reconfigurable logic circuit processor. Thus, the disclosed principles may be used as a platform in designing and developing the custom LSI, as well as in manufacturing an application specific custom LSI.

While various embodiments of the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A dynamically reconfigurable microprocessor comprising:
a program stack operable to receive a plurality of program instructions, the program instructions comprising at least first and second instruction sets; and
a reconfigurable logic circuit in electrical communication with the program stack, the reconfigurable logic circuit having alternative first and second data paths whereby data to be operated on according to the first instruction set passes through the first data path and data to be operated on according to the second instruction set passes through the second data path, and whereby the reconfigurable logic circuit is reconfigurable according to whether instructions corresponding to the first or second instruction set are being executed by the microprocessor.

2. A dynamically reconfigurable microprocessor according to claim 1, wherein the program stack is a part of a program controller, and wherein the program controller provides the electrical communication from the program stack to the reconfigurable logic circuit.

3. A dynamically reconfigurable microprocessor according to claim 1, wherein the first instruction set is a general purpose instruction set and wherein the first data path functionally comprises a general purpose microprocessor.

4. A dynamically reconfigurable microprocessor according to claim 3, wherein the second instruction set is a digital signal processing instruction set and wherein the second data path functionally comprises a digital signal processor.

5. A dynamically reconfigurable microprocessor according to claim 4, wherein the digital signal processing instruction set is optimized for encrypting or decrypting data.

6. A dynamically reconfigurable microprocessor according to claim 1, wherein the program instructions received in the program stack comprise at least a third instruction set and wherein the reconfigurable logic circuit further comprises a third data path whereby data to be operated on according to the third instruction set passes through the third data path, whereby the reconfigurable logic circuit is operable to be reconfigured according to whether instructions corresponding to the first, second, or third instruction sets are being executed upon.

7. A dynamically reconfigurable microprocessor according to claim 1, wherein the program stack is further in electrical communication with the reconfigurable logic circuit.

8. A dynamically reconfigurable microprocessor according to claim 7, wherein the electrical communication from the program stack to the reconfigurable logic circuit is through a configuration memory that stores at least one configuration of the reconfigurable logic.

9. A dynamically reconfigurable microprocessor according to claim 7, wherein the reconfigurable logic circuit comprises an array of programmable elements that may be alternatively selected whereby a first subset of the array of programmable elements is a part of the first data path and whereby a second subset of the array of programmable elements is a part of the second data path.

10. A dynamically reconfigurable microprocessor according to claim 9, wherein at least some of the array of programmable elements are a part of both of the first data path and the second data path.

11. A dynamically reconfigurable microprocessor according to claim 1, wherein at least one of the first and second instruction sets and the at least one instruction set's corresponding data path in the reconfigurable logic circuit are adapted to be defined after the microprocessor architecture has been laid out according to future design needs.

12. A dynamically reconfigurable microprocessor according to claim 11, wherein the corresponding data path comprises logic elements that can be selected according to manufacturing mask options.

13. A dynamically reconfigurable microprocessor according to claim 11, wherein the corresponding data path comprises programmable logic elements that can be programmed according to the design needs.

14. A dynamically reconfigurable microprocessor according to claim 13, wherein the programmable logic elements comprise gates of a Field Programmable Gate Array.

15. A dynamically reconfigurable microprocessor according to claim 13, wherein the programmable logic elements comprise gates of a Programmable Logic Device.

16. A dynamically reconfigurable microprocessor according to claim 1, wherein the data to be operated on according to the first or second instruction set comprises object code generated from a source application code.

17. A dynamically reconfigurable microprocessor according to claim 16, wherein the reconfigurable logic circuit is reconfigurable according to whether instructions corresponding to the first or second instruction set are being executed by the microprocessor using configuration information generated from the source application code.

18. A method of dynamically reconfiguring processing circuitry, the method comprising:
receiving a plurality of program instructions to be executed by the processing circuitry, the program instructions comprising at least first and second instruction sets;
configuring a reconfigurable logic circuit in a first data path when operating on data according to the first instruction set; and
configuring the reconfigurable logic circuit in a second data path when operating on data according to the second instruction set.

19. A method according to claim 18, wherein the first instruction set is a general purpose instruction set, the method comprising configuring the reconfigurable logic circuit in a first data path functionally comprising a general purpose microprocessor for operating on data according to the first instruction set.

20. A method according to claim 19, wherein the second instruction set is a digital signal processing instruction set, the method further comprising configuring the reconfigurable logic circuit in a second data path functionally comprising a digital signal processor for operating on data according to the second instruction set.

21. A method according to claim 20, wherein operating on data according to the second instruction set comprises encrypting or decrypting data.

22. A method according to claim 18, wherein receiving a plurality of program instructions further comprises receiving a plurality of program instructions comprising a third instruction set, wherein the method further comprises configuring the reconfigurable logic circuit in a third data path when operating on data according to the third instruction set.

23. A method according to claim 18, further comprising storing at least one configuration of the reconfigurable logic in a configuration memory.

24. A method according to claim 18, wherein configuring the reconfigurable logic circuit in a first or second data path comprises configuring an array of programmable elements that may be alternatively selected, whereby a first subset of the array of programmable elements is a part of the first data path and a second subset of the array of programmable elements is a part of the second data path.

25. A method according to claim 24, wherein at least some of the array of programmable elements are a part of both of the first data path and the second data path.

26. A method according to claim 18, wherein configuring the reconfigurable logic circuit in a first or second data path comprises configuring the reconfigurable logic circuit in a first or second data path after laying out the microprocessor architecture according to future design needs.

27. A method according to claim 26, wherein configuring the reconfigurable logic circuit in a first or second data path comprises selecting an array of programmable logic elements according to manufacturing mask options.

28. A method according to claim 26, wherein configuring the reconfigurable logic circuit in a first or second data path comprises programming the logic elements according to the design needs.

29. A custom LSI development platform for the development of structure and circuitry, the platform comprising:
an instruction set generator for generating instruction sets for a processor, the instructions comprising instructions from at least first and second instruction sets;
a compiler for generating instructions according to the generated instruction sets; and
a logic circuit configuration generator that generates logic circuit configuration information for first and second data paths within a dynamically reconfigurable logic circuit, wherein the first and second data paths provide circuitry that are operable for execution of the generated instructions from the respective first and second instruction sets.

30. A custom LSI development platform according to claim 29, and further comprising a dynamic reconfigurable processor reconfigured according to the logic circuit configuration information and operable to execute the generated instructions for LSI development purposes.

31. A custom LSI development platform according to claim 30, wherein the instruction set generator is operable to:
extract an instruction pattern from instructions in a program described in a high-level language;
compare the extracted instruction pattern with patterns of one or more custom instructions stored in a library; and
substitute the instruction pattern in the program with the one or more custom instructions.

32. A custom LSI development platform according to claim 31, wherein the instruction set generator is further operable to provide its generated instruction sets to the compiler by which the compiler is operable to generate the instructions.

33. A custom LSI development platform according to claim 32, wherein the generated instructions comprise object code.

34. A custom LSI development platform according to claim 31, wherein the dynamically reconfigurable processor further comprises:
a dynamically reconfigurable logic circuit;
a configuration memory that stores the logic circuit configuration information of the one or more custom instructions;
a memory that holds the one or more custom instructions;
a register file that temporarily holds the result of executing the one or more custom instructions; and
a controller that reads the logic circuit configuration information corresponding to the one or more custom instructions from the configuration memory and reconfigures the dynamically reconfigurable logic circuit when executing the one or more custom instructions.

35. A custom LSI development platform according to claim 34, wherein the controller further includes an index register for storing an index when accessing the memory.

36. A custom LSI development platform according to claim 35, wherein the processor further includes a stack for storing a value of the index register.

37. A custom LSI development platform according to claim 31, further comprising a creator for generating as a new custom instruction an instruction in the program that is not substituted with the one or more custom instruction when the instruction in the program is substituted with the one or more custom instructions.

38. A method for generating an instruction set architecture of a processor, the method comprising:
extracting an instruction pattern from an instruction in a program described in a high-level language;
comparing the extracted instruction pattern with patterns of one or more custom instructions stored in a library; and
substituting the instruction in the program with the one or more custom instructions to generate the instruction set architecture.

39. A method according to claim 38, further comprising extracting logic element connection information associated with the instruction substituted with the custom instruction, and generating the instruction set architecture from the logic element connection information and the custom instruction.

40. A method according to claim 39, further comprising storing the logic element connection information in the library so as to be associated with the custom instruction.

41. A method according to claim 40, wherein the processor is a dynamically reconfigurable logic circuit processor.

42. A method according to claim 38, further comprising adding to the library of one or more custom instructions a new custom instruction comprising an instruction in the program that is not substituted with the one or more custom instructions during the substituting.

43. A method for generating logic circuit configuration information for a processor, the method comprising:
extracting an instruction pattern from an instruction in a program described in a high-level language;
comparing the extracted instruction pattern with patterns of one or more custom instructions;
substituting the instruction in the program with the one or more custom instructions; and
generating the logic circuit configuration information from logic element connection information associated with the one or more custom instructions and from layout arrangement information of at least one programmable element of the processor.

44. A method according to claim 43, wherein the logic element connection information is stored in a library.

45. A method according to claim 43, wherein the processor is a dynamically reconfigurable logic circuit processor.

46. A dynamic logic circuit reconfigurable processor, comprising:
a dynamically reconfigurable logic circuit comprising at least one programmable element;
a configuration memory that stores layout arrangement information for each instruction of the at least one programmable element;
a register file that temporarily holds a middle result of executing the instructions of the at least one programmable element;
a memory that holds the instructions; and
a controller that manages the processor, the controller managing an executing order of the instructions of the at least one programmable element.

47. A dynamic logic circuit reconfigurable processor according to claim 46, wherein the instructions comprises at least first and second instruction sets, the logic circuit configurable into a first or a second data path according to whether instructions corresponding to the first or second instruction set are being executed by the processor.

48. A dynamic logic circuit reconfigurable processor according to claim 47, wherein the first instruction set is a general purpose instruction set and wherein the first data path functionally comprises a general purpose microprocessor.

49. A dynamic logic circuit reconfigurable processor according to claim 48, wherein the second instruction set is a digital signal processing instruction set and wherein the second data path functionally comprises a digital signal processor.

50. A dynamic logic circuit reconfigurable processor according to claim 49, wherein the digital signal processing instruction set is optimized for encrypting or decrypting data.

51. A dynamic logic circuit reconfigurable processor according to claim 47, wherein the reconfigurable logic circuit comprises an array of programmable elements that may be alternatively selected, whereby a first subset of the array of programmable elements is a part of the first data path and whereby a second subset of the array of programmable elements is a part of the second data path.

52. A dynamic logic circuit reconfigurable processor according to claim 51, wherein at least some of the array of programmable elements are a part of both of the first data path and the second data path.

53. A dynamic logic circuit reconfigurable processor according to claim 51, wherein the programmable logic elements comprise gates of a Field Programmable Gate Array.

54. A dynamic logic circuit reconfigurable processor according to claim 51, wherein the programmable logic elements comprise gates of a Programmable Logic Device.

55. A dynamic logic circuit reconfigurable processor according to claim 47, wherein the data to be operated on according to the first or second instruction set comprises object code generated from a source application code.

56. A dynamic logic circuit reconfigurable processor according to claim 55, wherein the reconfigurable logic circuit is reconfigurable according to whether instructions corresponding to the first or second instruction set are being executed by the processor using configuration information generated from the source application code.

57. A custom LSI development platform, comprising:
a dynamic logic circuit reconfigurable processor having at least one programmable element comprising the logic circuit; and
a software module, the software module comprising:
an instruction set architecture generator for generating an instruction set architecture of the processor, and
a logic circuit configuration generator that generates logic circuit configuration information of the processor from layout arrangement information of the at least one programmable element and the instruction set architecture.

58. A custom LSI development platform according to claim 57, wherein the instruction set architecture comprises at least first and second instruction sets, the logic circuit configuration generator generating configuration information to configure the logic circuit into a first or a second data path according to whether instructions corresponding to the first or second instruction set are being executed by the processor.

59. A custom LSI development platform according to claim 58, wherein the first instruction set is a general purpose instruction set and wherein the first data path functionally comprises a general purpose microprocessor.

60. A custom LSI development platform according to claim 59, wherein the second instruction set is a digital signal processing instruction set and wherein the second data path functionally comprises a digital signal processor.

61. A custom LSI development platform according to claim 60, wherein the digital signal processing instruction set is optimized for encrypting or decrypting data.

62. A custom LSI development platform according to claim 58, wherein the reconfigurable logic circuit comprises an array of programmable elements that may be alternatively selected whereby a first subset of the array of programmable elements is a part of the first data path and whereby a second subset of the array of programmable elements is a part of the second data path.

63. A custom LSI development platform according to claim 62, wherein at least some of the array of programmable elements are a part of both of the first data path and the second data path.

64. A custom LSI development platform according to claim 58, wherein at least one of the first and second instruction sets and the at least one instruction set's corresponding data path in the reconfigurable logic circuit are adapted to be defined after the microprocessor architecture has been laid out according to future design needs.

65. A custom LSI development platform according to claim 64, wherein the corresponding data path comprises logic elements that can be selected according to manufacturing mask options.

66. A custom LSI development platform according to claim 64, wherein the corresponding data path comprises programmable logic elements that can be programmed according to the design needs.

67. A custom LSI development platform according to claim 66, wherein the programmable logic elements comprise gates of a Field Programmable Gate Array.

68. A custom LSI development platform according to claim 66, wherein the programmable logic elements comprise gates of a Programmable Logic Device.

69. A custom LSI development platform according to claim 58, wherein the data to be operated on according to the first or second instruction set comprises object code generated from a source application code.

70. A custom LSI development platform according to claim 69, wherein the reconfigurable logic circuit is reconfigurable according to whether instructions corresponding to the first or second instruction set are being executed by the microprocessor using configuration information generated from the source application code.

71. A custom LSI development platform according to claim 57, further comprising a configuration memory connected to the logic circuit configuration generator that stores at least one configuration of the reconfigurable logic circuit.

72. A computer-readable medium containing a set of instructions to be executed in a computer for generating an instruction set architecture of a dynamic logic circuit reconfigurable processor, the set of instructions comprising:
extracting an instruction pattern from an instruction in an application program of the processor described in a high-level language;
comparing the extracted instruction pattern with patterns of one or more custom instructions stored in a library; and
substituting the instruction in the program with the one or more custom instructions to generate the instruction set.

73. A computer-readable medium according to claim 72, wherein the set of instructions further comprises extracting logic element connection information associated with the instruction substituted with the custom instruction, and generating the instruction set architecture from the logic element connection information and the custom instruction.

74. A computer-readable medium according to claim 73, wherein the set of instructions further comprises storing the logic element connection information in the library so as to be associated with the custom instruction.

75. A computer-readable medium according to claim 74, wherein the processor is a dynamically reconfigurable logic circuit processor.

76. A computer-readable medium according to claim 72, wherein the set of instructions further comprises adding to the library of one or more custom instructions a new custom instruction comprising an instruction in the program that is not substituted with the one or more custom instructions during the substituting.

77. A computer-readable medium containing a set of instructions to be executed in a computer for generating logic circuit configuration information for a dynamic logic circuit reconfigurable processor, the set of instructions comprising:
extracting an instruction pattern from an instruction in a program described in a high-level language;
comparing the extracted instruction pattern with patterns of one or more custom instructions;
substituting the instruction in the program with the one or more custom instructions to generate an instruction set; and
generating the logic circuit configuration information from logic element connection information associated with the one or more custom instructions included in the instruction set and from layout arrangement information of at least one programmable element of the processor.

78. A computer-readable medium according to claim 77, wherein the set of instructions further comprises extracting logic element connection information associated with the instruction substituted with the custom instruction, and generating the instruction set architecture from the logic element connection information and the custom instruction.

79. A computer-readable medium according to claim 78, wherein the set of instructions further comprises storing the logic element connection information in the library so as to be associated with the custom instruction.

80. A computer-readable medium according to claim 79, wherein the processor is a dynamically reconfigurable logic circuit processor.

81. A computer-readable medium according to claim 77, wherein the set of instructions further comprises adding to the library of one or more custom instructions a new custom instruction comprising an instruction in the program that is not substituted with the one or more custom instructions during the substituting.
